(19) United States
(12) Patent Application Publication
(10) Pub. No.: US 2006/0061964 A1
(43) Pub. Date: Mar. 23, 2006

(54) Mobile expansion unit for notebook

(75) Inventor: Hsiu-Huei Cheng, Gueishan Township (TW)

Correspondence Address: BACON & THOMAS, PLLC, 625 SLATERS LANE, FOURTH FLOOR, ALEXANDRIA, VA, 22314, US

(73) Assignee: Hsiu-Huei CHENG, Gueishan Township (TW)

(21) Appl. No.: 10/998,615

(22) Filed: Nov. 30, 2004

(30) Foreign Application Priority Data
Sep. 17, 2004 (TW) 093128331

(51) Int. Cl. G06F 1/20; G06F 1/16

(52) U.S. Cl. 361/687; 361/686; 361/683; 710/303; 710/304

(57) ABSTRACT

A mobile expansion unit for use with a notebook is disclosed to include a housing for supporting a notebook, fans mounted inside the housing for cooling the loaded notebook, and speakers mounted in the housing and spaced from the bottom surface of the loaded notebook at a distance that works to reinforce and prolong sound outputted from the loaded notebook through the speakers. Peripheral apparatus such as TV tuner card, card reader, USB hub, and etc. may be installed in the housing to expand the function of the notebook being used with the mobile expansion unit.

### BACKGROUND OF THE INVENTION

1. Field of the Invention

The present invention relates to a mobile expansion unit for notebook and more particularly, to such a mobile expansion unit for increasing output sound by speaker and dissipating heat from the notebook carried thereon.

2. Description of Related Art

Following fast development of high-tech, every industry is facing a surge of technological innovations that aim at manufacturing lighter, thinner, shorter and smaller products with higher quality. Nowadays, a notebook has become a requite implement to many people in working and living. Following increasing of CPU frequency and electronic device density and fast developing of versatile peripheral apparatus, a new generation notebook produces much heat, in consequence, increasing the risk of computer failure. Various methods and devices have been disclosed for use in or with a notebook to dissipate heat. There is known a mobile expansion unit for use with a notebook to dissipate heat during operation of the loaded notebook.

At present, there are many cases to use multimedia software. The demand for high quality audio output is more and more stronger. A notebook has built-in speakers for audio output. However, due to limited inside space, a notebook has no room for relatively bigger speakers that give a high quality audio output. External speakers may be connected to a notebook for audio output. However, it is inconvenient to carry external speakers with a notebook.

### SUMMARY OF THE INVENTION

The mobile expansion unit for use with a notebook in accordance with one embodiment of the present invention comprises a housing, at least one fan, at least one speaker, an audio input interface, a power supply device, and a control circuit board. The housing defines therein a receiving chamber, comprising a top surface and at least one peripheral surface. The top surface has at least one air inlet and at least one speaker hole. The at least one peripheral surface has at least one air outlet and an opening. The at least one air inlet and the at least one air outlet are in air communication with the receiving chamber. The at least one fan is respectively mounted inside the receiving chamber of the housing corresponding to the at least one air inlet. The at least one speaker is respectively mounted inside the receiving chamber of the housing corresponding to the at least one speaker hole. The audio input interface is mounted inside the receiving chamber of the housing corresponding to the opening for receiving audio signal from external sound source. The control circuit board is mounted inside the receiving chamber of the housing and electrically connected with the at least one fan, the at least one speaker, the audio input interface and the power supply device. The control circuit board is adapted to fetch audio signal from the audio input interface and drive the at least one speaker to output fetched audio signal.

After connection of a notebook to the mobile expansion slot, the at least one fan is started with the notebook to dissipate heat from the notebook. Further, the at least one built-in speaker increases sound from the loaded notebook or an external sound source. Spacer, for example, raised portions are provided at the top surface of the housing to keep the bottom surface of the loaded notebook spaced above the top surface of the housing at a distance that works as a resonant chamber to reinforce and prolong output sound from the at least one speaker.

Further, other peripheral apparatus such as TV tuner card, card reader, USB hub, and etc. may be installed in the housing of the mobile expansion unit to expand the function of the notebook being used with the mobile expansion unit.

### BRIEF DESCRIPTION OF THE DRAWINGS

FIG. 1 is a perspective assembly view of a mobile expansion unit for notebook according to the present invention.

FIG. 2 is an exploded view of the mobile expansion unit for notebook according to the present invention.

FIG. 3 is a schematic drawing showing the mobile expansion unit used with a notebook according to the present invention.

### DETAILED DESCRIPTION OF THE PREFERRED EMBODIMENT

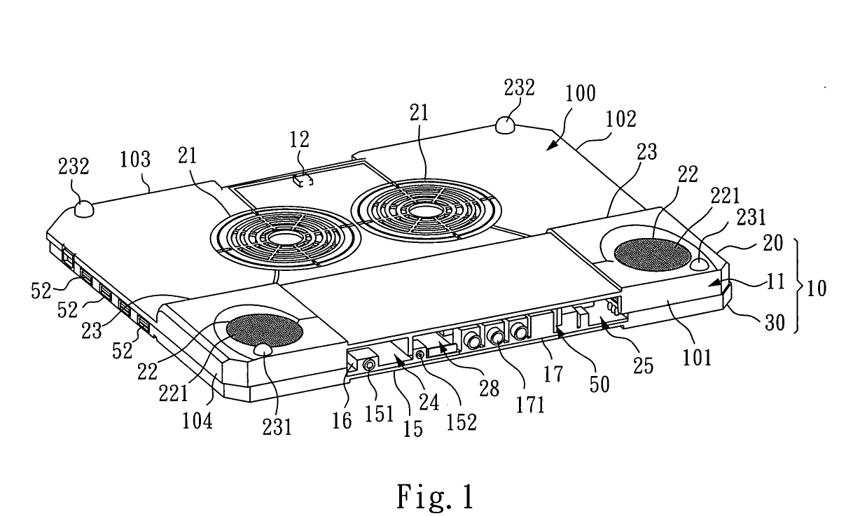

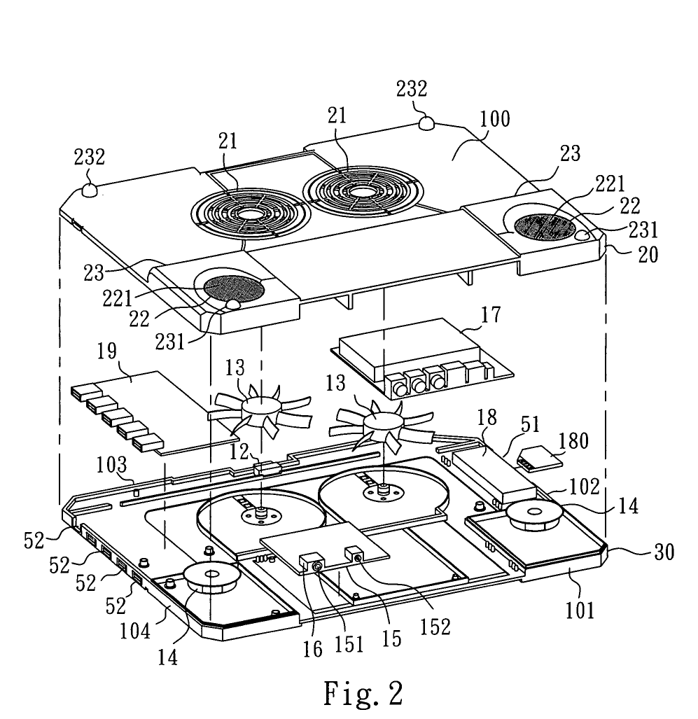

Referring to FIGS. 1 and 2, a mobile expansion unit 1 is shown comprising a housing 10, two fans 13, two speakers 14, an audio input interface 152, a power supply device 16, and a control circuit board 15. According to the present preferred embodiment, the housing 10 is formed of a top cover shell 20 and a bottom cover shell 30. The top cover shell 20 covers the bottom cover shell 30, defining with the bottom cover shell 30 a receiving chamber 11. The housing 10 has a top surface 100 and a plurality of peripheral surfaces 101, 102, 103 and 104. The top surface 100 is provided with two air inlets 21 and two speaker holes 22. One peripheral surface 101 has two air outlets 24 and 25 and an opening 28. The air inlet 21 and the air outlets 24 and 25 are kept in air communication with the receiving chamber 11 for ventilation.

Referring to FIG. 2 again, the fans 13 are respectively mounted inside the receiving chamber 11 of the housing 10 corresponding to the air inlets 21 for expelling air out of the mobile expansion unit 1. The speakers 14 are respectively mounted inside the receiving chamber 11 of the housing 10 corresponding to the speakers 22 for output of audio signal received from an external apparatus, for example, a notebook through the audio input interface 152. The audio input interface 152 is mounted inside the receiving chamber 11 of the housing 10 corresponding to the opening 28 for receiving audio signal from an external apparatus.

The aforesaid control circuit board 15 is mounted inside the receiving chamber 11 of the housing 10, and electrically connected with the fans 13, the speakers 14, the audio input interface 152 and the power supply device 16. The control circuit board 15 fetches audio signal from the audio input interface 152, and controls the speaker 14 to output fetched audio signal. Further, the control circuit board 15 also controls the operation of the fans 13 of the mobile expansion unit 1. The aforesaid power supply device 16 comprises a power input terminal 151 for receiving external power supply and providing power supply to the mobile expansion unit 1. The power supply device 16 can be an AC adapter for converting external Ac power supply into DC power supply. Alternatively, the power supply device 16 can be a battery set. According to the present preferred embodiment, the power supply device 16 and the power input terminal 151 are installed in the control circuit board 15. Alternatively, the power input terminal 151 can be installed in another part of the mobile expansion unit 1. The invention further comprises a switch 12 adapted to switch on/off the mobile expansion unit 1.

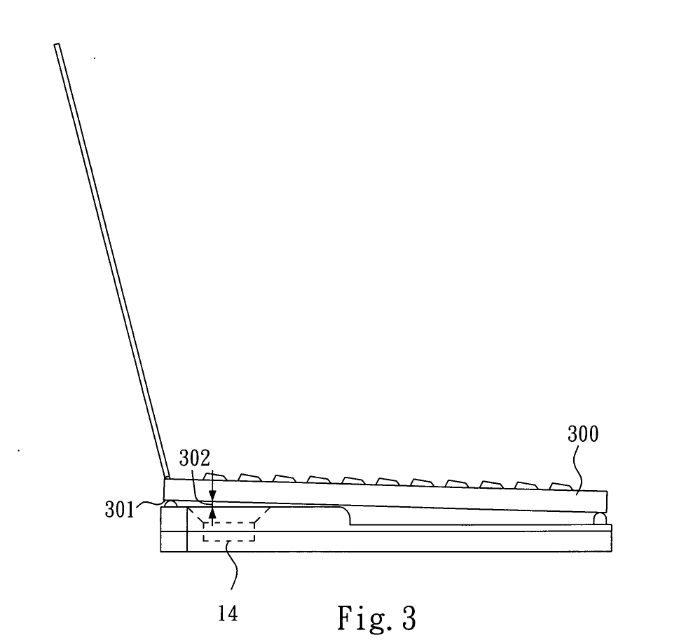

FIG. 3 shows the mobile expansion unit 1 used with a notebook 300. Referring to FIG. 3 and FIGS. 1 and 2 again, the top surface 100 of the housing 10 has an upper part 23 and raised portions 231 and 232. According to the present preferred embodiment, the speaker holes 22 are formed in the upper part 23 of the top surface 100 of the housing 10 and covered with a respective grille 221. After positioning of the notebook 300 in the mobile expansion unit 1, the raised portions 231 support the notebook 300 in position and keep the bottom surface 301 of the notebook 300 spaced above the top surface 100 of the housing 10 at a distance 302, which works as a resonant chamber to reinforce and prolong sound outputted through the speakers 14.

Referring to FIGS. 1 and 2, the mobile expansion unit 1 further comprises a TV tuner card 17 mounted inside the receiving chamber 11 of the housing 10. One peripheral surface 101 of the housing 10 has an expansion slot 50. The TV tuner card 17 is aimed at the expansion slot 50 through which external devices can be connected to the audio video connection ports 171 (AV terminal, S terminal, digital TV connection port, etc.) of the TV tuner card 17.

The mobile expansion unit 1 further comprises a card reader 18 mounted inside the receiving chamber 11 of the housing 10 corresponding to one expansion slot 51 in one peripheral surface 102 of the housing 10. Through the expansion slot 51, a memory card 180 can be inserted into the card reader 18. The card reader 18 can be any of a variety of types for reading CF, MS, SD, XD, MMC, RS-MMC, or other mobile memory cards. The mobile expansion unit 1 further comprises a USB hub 19 mounted inside the receiving chamber 11 of the housing 10 corresponding to one expansion slot 52 in one peripheral surface 104 of the housing 10, so that the loaded notebook 300 can be linked to the mobile expansion unit 1 through the USB hub 19 for transmission of data and signal therebetween.

Although the present invention has been explained in relation to its preferred embodiment, it is to be understood that many other possible modifications and variations can be made without departing from the spirit and scope of the invention as hereinafter claimed.

What is claimed is:

1. A mobile expansion unit for notebook, comprising:
a housing, said housing defining therein a receiving chamber, said housing comprising a top surface and at least one peripheral surface, said top surface having at least one air inlet and at least one speaker hole, said at least one peripheral surface having at least one air outlet and an opening, said at least one air inlet and said at least one air outlet being in air communication with said receiving chamber;
at least one fan mounted inside said receiving chamber of said housing corresponding to said at least one air inlet;
at least one speaker mounted inside said receiving chamber of said housing corresponding to said at least one speaker hole;
an audio input interface mounted inside said receiving chamber of said housing corresponding to said opening for receiving audio signal from external sound source;
power supply device; and
a control circuit board mounted inside said receiving chamber of said housing and electrically connected with said at least one fan, said at least one speaker, said audio input interface and said power supply, said control circuit board being adapted to fetch audio signal from said audio input interface and drive said at least one speaker to output fetched audio signal.

2. The mobile expansion unit for use with a notebook as claimed in claim 1, wherein said top surface of said housing has an upper part; said at least one speaker hole is respectively formed in said upper part.

3. The mobile expansion unit for use with a notebook as claimed in claim 1, wherein said top surface of said housing has at least one raised portion for spacing a notebook above said top surface of said housing.

4. The mobile expansion unit for use with a notebook as claimed in claim 1, further comprising a TV tuner card mounted inside said receiving chamber of said housing, and an expansion slot formed in said at least one peripheral surface of said housing corresponding to said TV tuner card.

5. The mobile expansion unit for use with a notebook as claimed in claim 1, wherein said power supply comprises a power input terminal for receiving external power supply.

6. The mobile expansion unit for use with a notebook as claimed in claim 5, said power input terminal is installed in said control circuit board.

7. The mobile expansion unit for use with a notebook as claimed in claim 1, further comprising a card reader mounted inside said receiving chamber of said housing, and an expansion slot formed in said at least one peripheral surface of said housing corresponding to said card reader.

8. The mobile expansion unit for use with a notebook as claimed in claim 1, further comprising a USB hub mounted inside said receiving chamber of said housing, and an expansion slot formed in said at least one peripheral surface of said housing corresponding to said USB hub.

9. The mobile expansion unit for use with a notebook as claimed in claim 1, wherein said housing is formed of a top cover shell and a bottom cover shell, said top cover shell being covered on said bottom cover shell and defining with said bottom cover said receiving chamber.
